(19) United States
(12) Patent Application Publication
(10) Pub. No.: US 2016/0154425 A1
(43) Pub. Date: Jun. 2, 2016

(54) WEARABLE ELECTRONIC DEVICE

(71) Applicants: SHENZHEN FUTAIHONG PRECISION INDUSTRY CO., LTD., Shenzhen (CN); FIH (HONG KONG) LIMITED, Kowloon (HK)

(72) Inventors: NAI-LIN YANG, New Taipei (TW); QIANG WANG, Shenzhen (CN); BING ZHANG, Shenzhen (CN)

(21) Appl. No.: 14/641,606

(22) Filed: Mar. 9, 2015

(30) Foreign Application Priority Data
Nov. 28, 2014 (CN) 201410700030.3

(51) Int. Cl. G06F 1/16

(52) U.S. Cl. CPC G06F 1/163

(57) ABSTRACT

A wearable electronic device includes a first casing, a second casing, and a main body. The second casing is detachably attached to the first casing. The main body is sandwiched between the first casing and the second casing and includes an electronic component assembly and a housing. The housing defines two holder spaces on opposite sides to receive the electronic component assembly, the housing is configured to latch to the first casing.

### FIELD

The subject matter herein generally relates to a wearable electronic device, and particularly relates to a wearable electronic device capable of changing cases.

### BACKGROUND

Wearable electronic devices are coupled to human body, either multifunctional or changeable appearance is needed.

### BRIEF DESCRIPTION OF THE DRAWINGS

Implementations of the present technology will now be described, by way of example only, with reference to the attached figures.

FIG. 1 is an isometric view of an exemplary embodiment of a wearable electronic device.

FIG. 2 is an exploded view of the wearable electronic device of FIG. 1.

FIG. 3 is another exploded view of the wearable electronic device of FIG. 1.

FIG. 4 is an exploded view of a chip module of the wearable electronic device.

FIG. 5 is another exploded view of the chip module of the wearable electronic device.

FIG. 6 is a cross-sectional view of the wearable electronic device taken along line VI-VI of FIG. 1.

FIG. 7 is a cross-sectional view of a second embodiment of a wearable electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

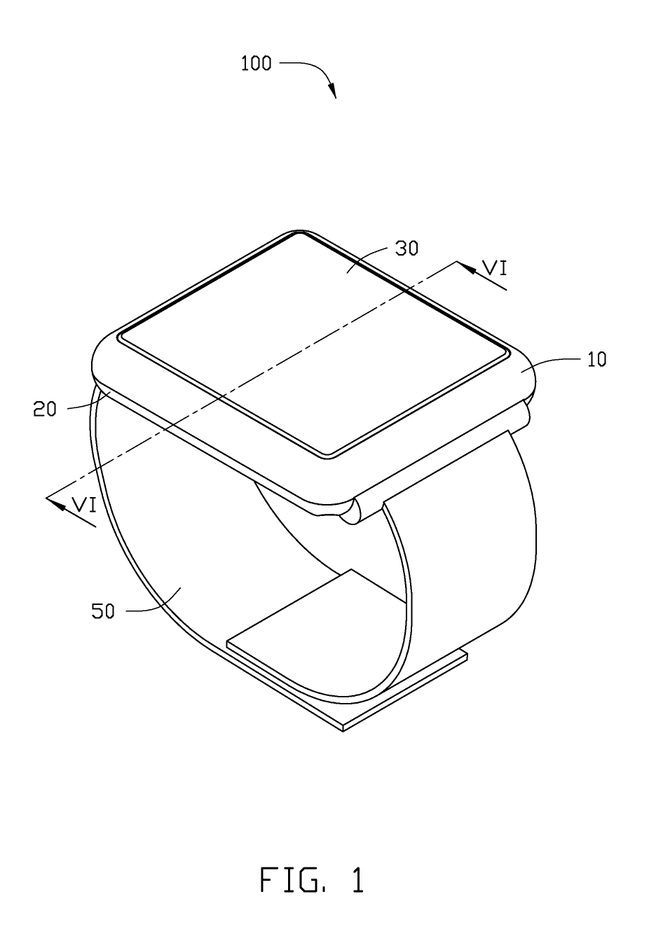

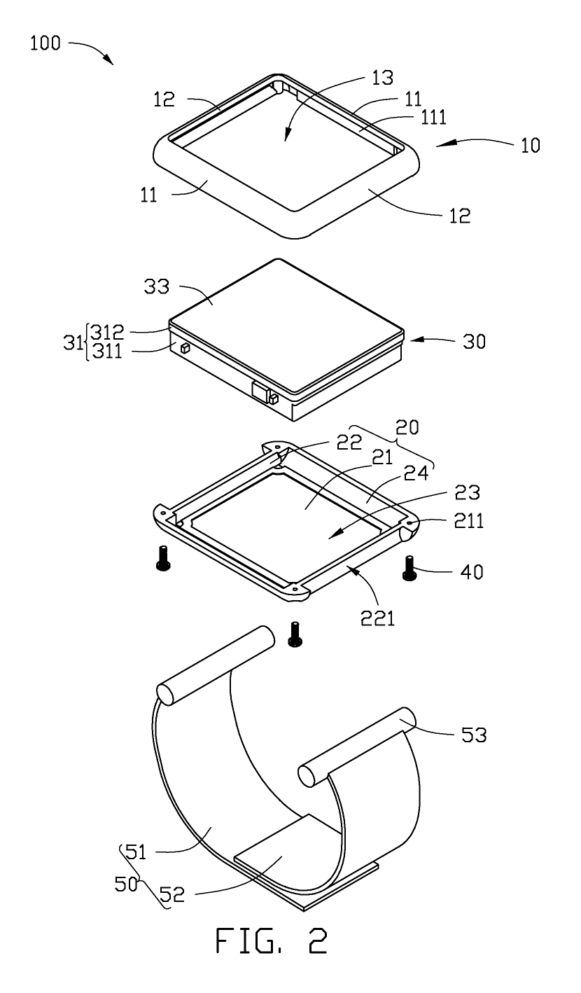

FIGS. 1 and 2 illustrate an exemplary embodiment of a wearable electronic device 100, which can be a smart watch, a smart wrist strap, or a smart headgear. The wearable electronic device 100 includes a first casing 10, a second casing 20, a main body 30, a fasten module 40, and a connecting module 50. The first casing 10 is coupled or attached to the second casing 20. The main body 30 is sandwiched between the first casing 10 and the second casing 20. The fasten module 40 is configured to fasten the first casing 10 and the second casing 20. The connecting module 50 is coupled to the second casing 20 and configured to couple the wearable electronic device 100 to a human body.

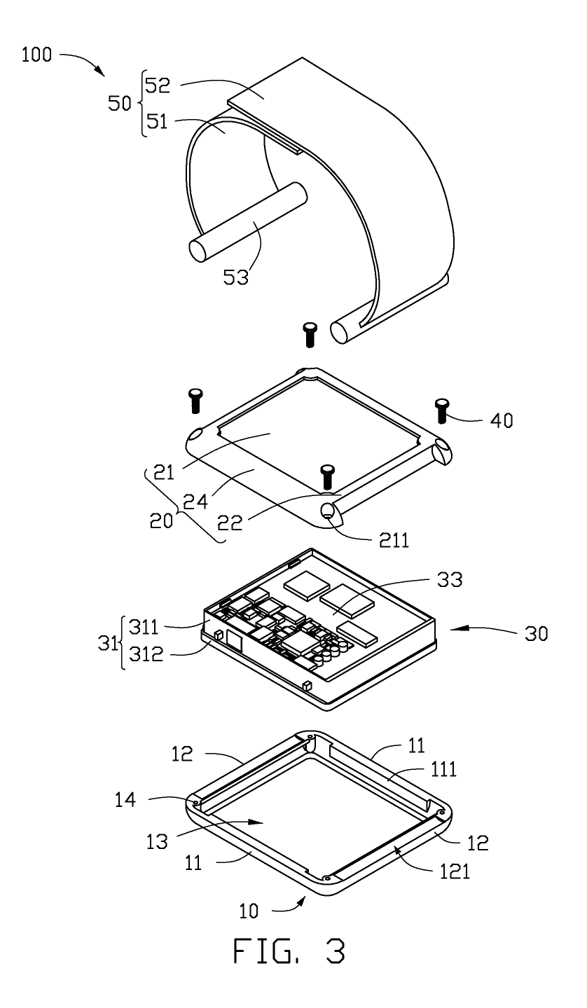

FIGS. 2 and 3 illustrate exploded views of the wearable electronic device 100. The first casing 10 is substantially a rectangular frame and includes two opposite first cover sidewalls 11 and two opposite second cover sidewalls 12. The two first cover sidewalls 11 and the two second cover sidewalls 12 enclose a receiving space 13. The first casing 10 defines four positioning holes 14 on four corners. Each first cover sidewall 11 includes a block 111 protruding towards the receiving space 13. Each second cover sidewall 12 defines an arcuate slot 121.

The second casing 20 is substantially a rectangular frame and includes a support board 21, two opposite first support sidewalls 22 and two opposite second support sidewalls 24. The two first support sidewalls 22 and the two second support sidewalls 24 are perpendicularly coupled to four edges of the support board 21. The support board 21, the two first support sidewalls 22 and the two second support sidewalls 24 enclose a receiving chamber 23. The second casing 20 defines four fixing holes 211 on four corners corresponding to the four positioning holes 14. Each first support sidewall 22 defines an opening 221 corresponding to one of the slot 121.

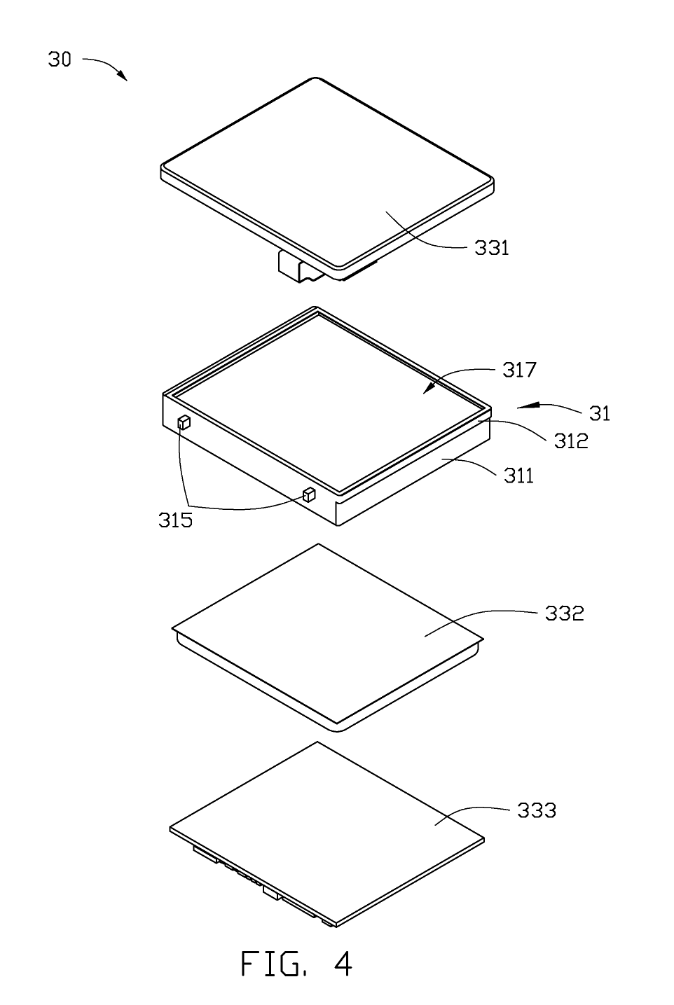

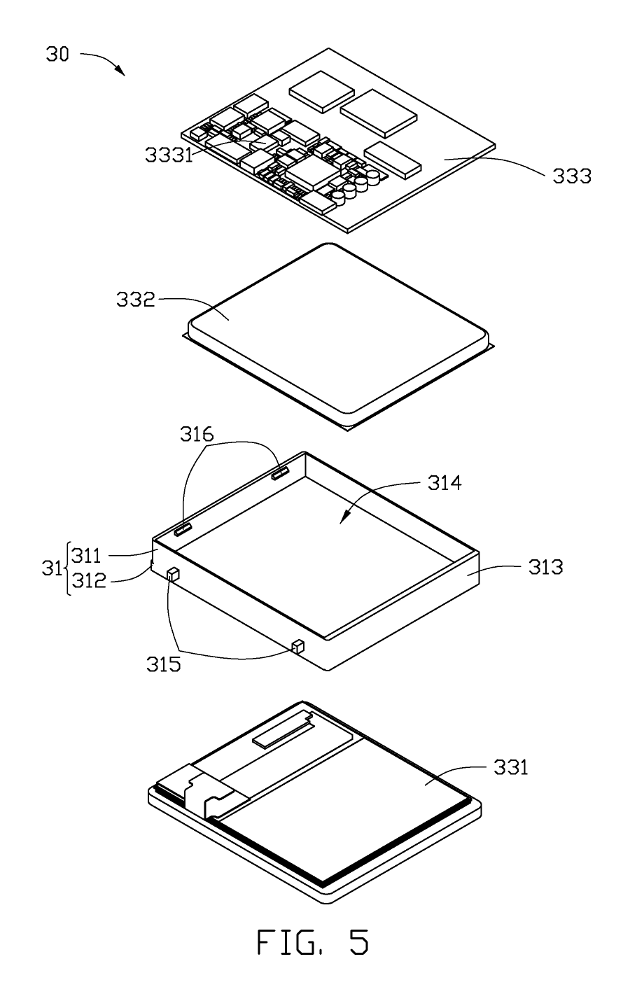

FIGS. 4 and 5 illustrate that the main body 30 includes an electronic component assembly 31 and a housing 33. The housing 31 includes a holder frame 311 and a holder board 312. The holder board 312 is covered to the holder frame 311 and has a greater size than that of the holder frame 311. The holder frame 311 is substantially rectangular and includes four holder sidewalls 313 perpendicularly connected in order. The holder sidewalls 313 enclose a first holding space 314. Two opposite holder sidewalls 313 dispose a latching piece 315 each backwardly protruding from the first holding space 314. Two other opposite holder sidewalls 313 dispose a limiting piece 316 each protruding towards the first holding space 314. The holder board 312 recesses from a side opposite to the first holder space 314 to form a second holder space 317.

The electronic component assembly 33 at least includes a display module 331, a power supply module 332 and a circuit board 333. The display module 331 is received in the second holder space 317. The power supply module 332 and the circuit board 333 are overlap received in the first holder space 314. In one embodiment, the display module 331 can be a touch screen. The power supply module 332 is configured to supply power for the wearable electronic device 100. The circuit board 333 includes a plurality of electronic components 3331, which may include a camera, a headphone connector, a microphone, a USB connector, and an antenna etc.

In at least one embodiment, the fasten module 40 includes four screws. The connecting module 50 includes a first connecting belt 51 and a second connecting belt 52 detachably coupled to the first connecting belt 51. The first connecting belt 51 and the second connecting belt 52 each includes a rotatable portion 53 on one end, and each rotatable portion 53 is received in one of the opening 221, thereby the first connecting belt 51 and the second connecting belt 52 can be connected to the second casing 20. A free end of each of the first connecting belt 51 and the second connecting belt 52 can be coupled to each other to form a closed annularity to apply to a wrist of the user.

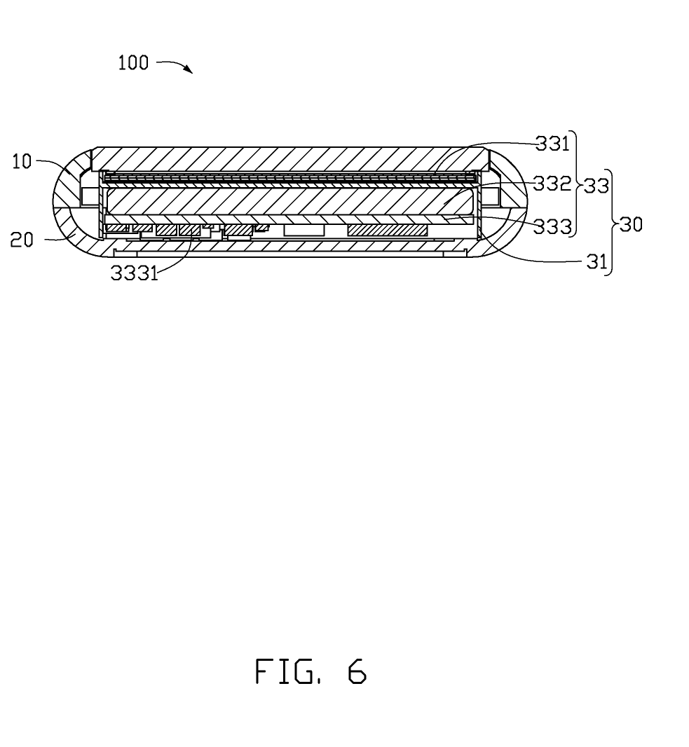

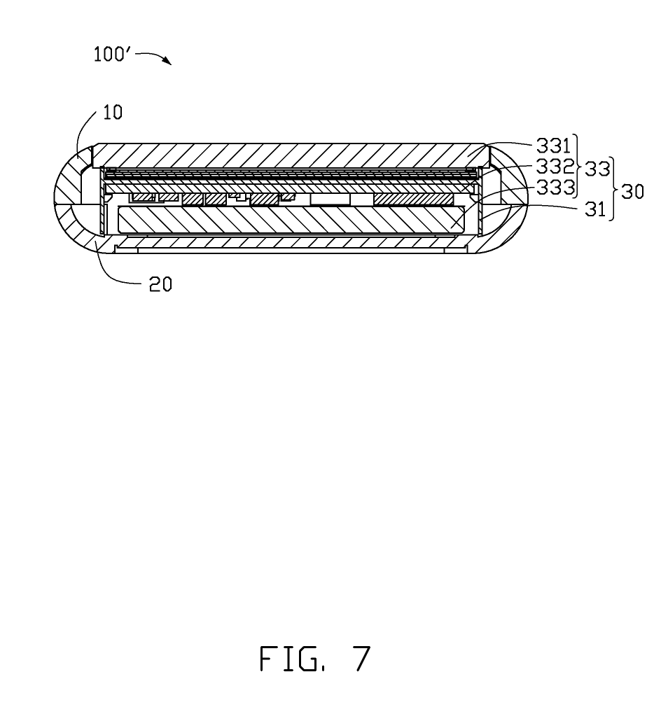

FIGS. 6 and 7 illustrate that the wearable electronic device 100 is assembled. The display module 331 is received in the second holder space 317 of the holder board 312. The power supply module 332 is received in the first holder space 314, the circuit board 333 is overlapped to the power supply module 332 and received in the first holder space 314, and peripheral edges of the circuit board 333 latch to the limiting pieces 316, thereby the power supply module 332 and the circuit board 333 are firmly received in the first holder space 314. In at least one embodiment, the display module 331 and the power supply module 332 can be plated to the second holder space 317 and the first holder space 314, respectively. Thereby the electronic component assembly 33 is assembled to the housing 31 to form the main body 30. The main body 30 is received in the receiving chamber 23 of the second casing 20. The first casing 10 is covered to the second casing 20. The latching pieces 315 latch to the corresponding blocks 111, thereby the main body 30 is firmly coupled to the first casing 10 and the second casing 20. The display module 331 is exposed from the receiving space 13. Each fasten piece 40 is coupled through the corresponding fixing hole 211 and the corresponding positioning hole 14 to lock the first casing 10 and the second casing 20 together.

FIG. 7 illustrates a second embodiment of the wearable electronic device 100 that substantially similar to the first embodiment. When the wearable electronic device 100 of the second embodiment is assembled, the circuit board 333 is received in the first holder space 314, the power supply module 332 is firmly overlapped on the circuit board 333, thereby to decrease a thickness of the wearable electronic device 100.

In other embodiments, the first casing 10 and the second casing 20 can be designed as other configurations, such as circular or cordiform. In addition, the first casing 10 and the second casing 20 can be made of different materials, textures, and colors. And then main body 30 is covered by the first casing 10 and the second casing 20, thus to change an appearance of the wearable electronic device 100.

The wearable electronic device 100 can change the first casing 10 and the second casing 20 different configurations to the main body 30, thereby a changeable appearance of the wearable electronic device 100 is provided. In addition, the power supply module 332 and the circuit board 333 are overlapped, which decrease a thickness of the wearable electronic device 100.

It is believed that the embodiments and their advantages will be understood from the foregoing description, and it will be apparent that various changes may be made thereto without departing from the scope of the disclosure or sacrificing all of its advantages, the examples hereinbefore described merely being illustrative embodiments of the disclosure.

What is claimed is:

1. A wearable electronic device comprising:
a first casing;
a second casing detachably coupled to the first casing; and
a main body sandwiched between the first casing and the second casing and comprising:
an electronic component assembly; and
a housing defining two holder spaces on opposite sides to receive the electronic component assembly, the housing configured to latch to the first casing.

2. The wearable electronic device as claimed in claim 1, wherein the housing comprises a holder frame and a holder board, the holder board is covered to the holder frame, the two holder spaces are defined in the holder frame and comprises a first holder space and a second holder space, the holder board recesses from a side opposite to the first holder space to form the second holder space.

3. The wearable electronic device as claimed in claim 2, wherein the holder frame is substantially rectangular and comprises four holder sidewalls perpendicularly connected in order, the holder sidewalls enclose the first holding space, two opposite holder sidewalls dispose a latching piece each backwardly protruding from the first holding space; two other opposite holder sidewalls dispose a limiting piece each protruding towards the first holding space.

4. The wearable electronic device as claimed in claim 3, wherein the electronic component assembly at least comprises a display module, a power supply module and a circuit board, the display module is received in the second holder space; the power supply module and the circuit board are overlapped and both are received in the first holder space.

5. The wearable electronic device as claimed in claim 4, wherein the power supply module is received in the first holder space and adjacent to the holder board, the circuit board closes to the power supply module, peripheral edges of the circuit board latch to the limiting pieces.

6. The wearable electronic device as claimed in claim 4, wherein the circuit board is received in the first holder space and adjacent to the holder board, the power supply module closes to the circuit board, peripheral edges of the power supply module latch to the limiting pieces.

7. The wearable electronic device as claimed in claim 4, wherein the first casing comprises two opposite first cover sidewalls and two opposite second cover sidewalls, the two first cover sidewalls and the two second cover sidewalls enclose a receiving space; each first cover sidewall disposes a block protruding towards the receiving space; each second cover sidewall defines a slot.

8. The wearable electronic device as claimed in claim 7, wherein the second casing comprises a support board, two opposite first support sidewalls and two opposite second support sidewalls, the two first support sidewalls and the two second support sidewalls are perpendicularly coupled to four edges of the support board and cooperatively enclose a receiving chamber; each first support sidewall defines an opening corresponding to one of the slot.

9. The wearable electronic device as claimed in claim 8, further comprising a connecting module configured to couple the wearable electronic device to a human body, wherein the connecting module comprises a first connecting belt and a second connecting belt, the first connecting belt and the second connecting belt each includes a rotatable portion on one end, and each rotatable portion is received in one of the opening, thereby the first connecting belt and the second connecting belt are connected to the second casing; a free end of each of the first connecting belt and the second connecting belt are coupled to each other, thereby to form a close annularity.

10. The wearable electronic device as claimed in claim 8, wherein when the main body is sandwiched between the first casing and the second casing, the main body is received in the receiving space and the receiving chamber, the display module is exposed from the receiving space; the latching pieces latch to the blocks.

11. A wearable electronic device comprising:
a first casing;
a second casing detachably attached to the first casing; and
a main body sandwiched between the first casing and the second casing and comprising an electronic component assembly and a housing, the housing defining two holder spaces on opposite sides to receive the electronic component assembly, the housing configured to latch to the first casing;
wherein the first casing and the second casing are configured to be different configurations, materials, or textures so as to be changeable for the wearable electronic device.

12. The wearable electronic device as claimed in claim 11, wherein the housing comprises a holder frame and a holder board, the holder board is covered to the holder frame, the two holder spaces are defined in the holder frame and comprises a first holder space and a second holder space, the holder board recesses from a side opposite to the first holder space to form the second holder space.

13. The wearable electronic device as claimed in claim 12, wherein the holder frame is substantially rectangular and comprises four holder sidewalls perpendicularly connected in order, the holder sidewalls enclose the first holding space, two opposite holder sidewalls dispose a latching piece each backwardly protruding from the first holding space; two other opposite holder sidewalls dispose a limiting piece each protruding towards the first holding space.

14. The wearable electronic device as claimed in claim 13, wherein the electronic component assembly at least comprises a display module, a power supply module and a circuit board, the display module is received in the second holder space; the power supply module and the circuit board are overlapped and both are received in the first holder space.

15. The wearable electronic device as claimed in claim 14, wherein the power supply module is received in the first holder space and adjacent to the holder board, the circuit board closes to the power supply module, peripheral edges of the circuit board latch to the limiting pieces.

16. The wearable electronic device as claimed in claim 14, wherein the circuit board is received in the first holder space and adjacent to the holder board, the power supply module closes to the circuit board, peripheral edges of the power supply module latch to the limiting pieces.

17. The wearable electronic device as claimed in claim 14, wherein the first casing comprises two opposite first cover sidewalls and two opposite second cover sidewalls, the two first cover sidewalls and the two second cover sidewalls enclose a receiving space; each first cover sidewall disposes a block protruding towards the receiving space; each second cover sidewall defines a slot.

18. The wearable electronic device as claimed in claim 17, wherein the second casing comprises a support board, two opposite first support sidewalls and two opposite second support sidewalls, the two first support sidewalls and the two second support sidewalls are perpendicularly coupled to four edges of the support board and cooperatively enclose a receiving chamber; each first support sidewall defines an opening corresponding to one of the slot.

19. The wearable electronic device as claimed in claim 18, further comprising a connecting module configured to couple the wearable electronic device to a human body, wherein the connecting module comprises a first connecting belt and a second connecting belt, the first connecting belt and the second connecting belt each includes a rotatable portion on one end, and each rotatable portion is received in one of the opening, thereby the first connecting belt and the second connecting belt are connected to the second casing; a free end of each of the first connecting belt and the second connecting belt are coupled to each other, thereby to form a close annularity.

20. The wearable electronic device as claimed in claim 18, wherein when the main body is sandwiched between the first casing and the second casing, the main body is received in the receiving space and the receiving chamber, the display module is exposed from the receiving space; the latching pieces latch to the blocks.
